(19) United States
(12) Patent Application Publication
(10) Pub. No.: US 2011/0119069 A1
(43) Pub. Date: May 19, 2011

(54) METHODS AND SYSTEMS FOR RECURRING FEATURE SUBSCRIPTION SERVICE

(76) Inventors: ANIKA SZUPPA, BERLIN (DE); ALFRED VAN DE POL, BERLIN (DE)

(21) Appl. No.: 12/777,123

(22) Filed: May 10, 2010

Related U.S. Application Data
(60) Provisional application No. 61/182,651, filed on May 29, 2009.

(51) Int. Cl. G06Q 10/00

(52) U.S. Cl. 705/1.1

(57) ABSTRACT

A subscription module is configured to extend a service and to prevent the service from being stopped after a first time period. The subscription module is further configured to cause the service to be perceived as a new service even after expiration of the first time period. The service is to be associated with a unique resource locator during the first time period and after the first time period has expired.

### CROSS-REFERENCE TO RELATED APPLICATIONS

This application claims the benefit of priority of U.S. Provisional Application No. 61/182,651, filed May 29, 2009, entitled “Methods and Systems for Recurring Feature Subscription Service,” which is incorporated herein by reference in its entirety.

### FIELD

The present application relates generally to the technical field of data processing and, in one specific example, to a method and system of processing recurring subscription services.

### BACKGROUND

Online services such as online marketplaces display information in their web pages in certain orders. Typically, the information toward the top of the web page or the information that is highlighted gets the most attention from their users.

### BRIEF DESCRIPTION OF THE DRAWINGS

Some embodiments are illustrated by way of example and not limitation in the figures of the accompanying drawings in which:

FIG. 1 illustrates a network diagram depicting a system, according to an example embodiment, having a client-server architecture.

FIG. 2 illustrates a block diagram showing a network-based marketplace and payment application(s) in an example embodiment.

FIG. 3 is a flow diagram illustrating one example of operations that may be performed by the recurring-feature subscription service application(s), in accordance with some example embodiments.

FIG. 4A is a block diagram illustrating one example a recurring service application, in accordance with some example embodiments.

FIG. 4B is a flow diagram illustrating one example of operations that may be performed by the recurring-feature subscription service application(s), in accordance with some example embodiments.

FIGS. 5A and 5B are a screen shot examples of an advertisement associated with a first resource locator during a first time period and a second resource locator during a second time period, in accordance with some example embodiments.

FIG. 6 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

For some example embodiments, methods and systems to process recurring features based on subscriptions are disclosed. The recurring features may be applied to a service. The service may expire after a period of time. When the subscription is activated, the service will be prevented from expiring while the subscription remains valid. When the service is associated with a subscription, the service retains at least some of the characteristics that enable the service to be more visible to users and to search engines.

In the following description, for purposes of explanation, numerous specific details are set forth in order to provide a thorough understanding of the present application. It will be evident, however, to one skilled in the art that the present application may be practiced without these specific details.

### Architecture

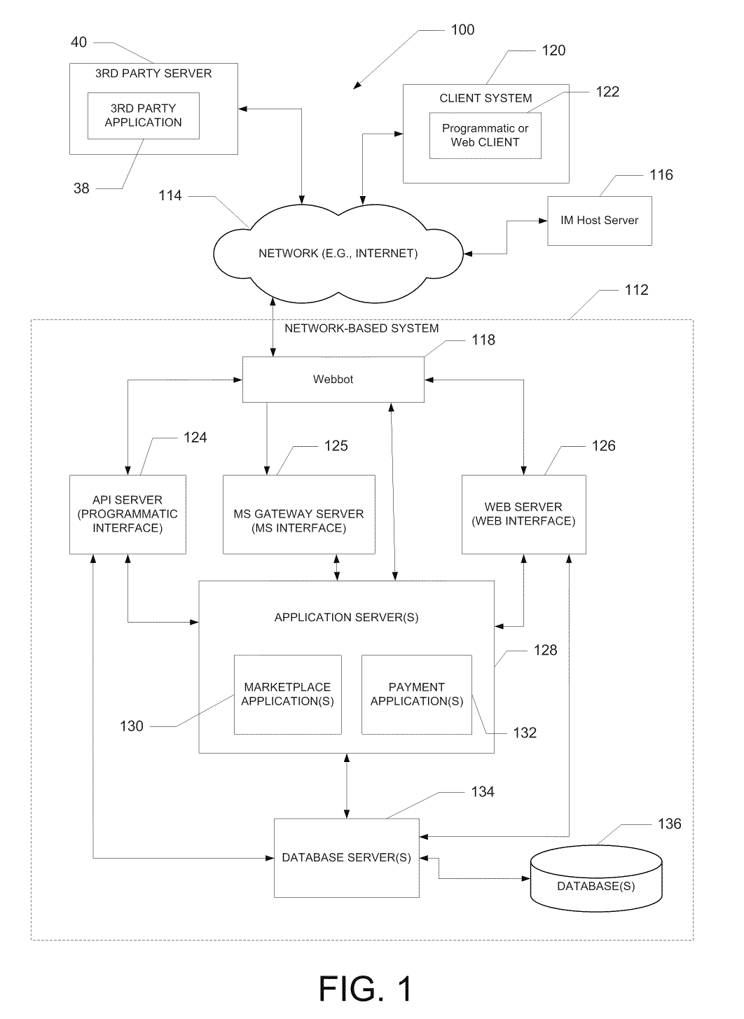

FIG. 1 illustrates a network diagram depicting a system 100 having a client-server architecture, according to an example embodiment of the present invention. A system, in the example form of a network-based system 112, provides server-side functionality, via a network 114 (e.g., the Internet, a public or private telephone network (wireline or wireless), a private wireless network using technologies such as Bluetooth or IEEE 802.11x or other networks) to one or more clients. FIG. 1 illustrates, for example, a programmatic/web client 122 may include a browser (e.g., the Internet Explorer® browser developed by Microsoft®), a device application, and/or a programmatic client executing on client system 120, e.g., on a network-based device. Further, while the system 100 shown in FIG. 1 employs a client-server architecture, embodiments are of course not limited to such an architecture, and could equally well find applications in a distributed, or peer-to-peer, architecture system.

The network 114 may include a mobile telephone network, a wireless wide area network (WWAN), a wireline telephone network, a wireless local area network (wireless LAN or WLAN), a wireless Metropolitan Area Network (MAN), and/or a wireless personal area network (PAN) (e.g., a Bluetooth® network). Other network-based technologies that may be used to connect include PON, VSAT satellite, Micro-impulse Radar, Radio Frequency identification (RFID), UltraWide Band, and/or Infrared. The network-based device may connect to the web using mobile internet exchange, e.g. Wireless Application Protocol (WAP) and/or Hypertext Transport Protocol (HTTP).

The client system (or network-based device(s)) 120, may include a mobile device, a palmtop computer, a laptop computer, a desktop computer, a personal digital assistant, a cellular telephone, a communications device, a wireless telephone, a land-line telephone, a control system, a camera, a scanner, a television, television cable, a telephone with a web browser, a facsimile machine, a printer, a pager, and/or a personal trusted device. There may be one or more client systems 120.

The client system 120 may include a card, such as a smart card, a magnetic card, and/or a key card. The device may include a telephone or any device capable of Short Messaging Service (SMS) messaging, instant messaging (IM), text messaging, multimedia messaging service (MMS) messaging and/or generating audio tones, such as dual-tone multi-frequency (DTMF) tones. The device may be browser-enabled. The client system 120 may enable mobile videophone communications, digital television signals, and/or digital radio signals. The device may include a receiver to receive near field communications. The scanner device may include a bar code reader/scanner, a Radio Frequency Interface System (RFIS) reader, and/or a symbol reader/scanner.

For some example embodiments, the client system 120 may be used by a consumer to authorize a payment facilitator to pay a portion of an electronic invoice.

The client system 120 may engage in an interactive message and/or open communication session, such as SMS, IM, electronic mail, xHTML, XML, Wireless Application Protocol (WAP), web, interactive voice response (IVR) and/or other mobile interfaces. The interactive messaging or open communication session may involve multiple technology modalities, e.g., the client user may engage the system via instant messaging (IM) and receive a responsive communication from the network-based system 112 via e-mail with an embedded hyperlinked Uniform Resource Locator (URL) directing the client user's device to a WAP or web page or via a telephone call. A hyperlinked URL may be delivered directly to the device from one or more application server(s) 128 of network-based system 112 and may be used to access a web site or a microbrowser, such as a WAP site.

Turning specifically to the network-based system 112, the one or more application servers 128 may host one or more marketplace application(s) 130 and one or more payment application(s) 132.

The marketplace application(s) 130 may provide a number of marketplace functions and services to client users, such as a buyer, and/or to third parties, such as sellers, vendors, or any user, who access the network-based system 112. The marketplace applications 130 may provide a number of offering mechanisms and price-setting mechanisms; whereby a seller may list goods or services for sale, a seller may promote their offers, a buyer can express interest in or indicate a desire to purchase such goods or services or to donate, and a price can be set for a transaction pertaining to the goods or services.

Payment applications 132 may provide a number of payment services and functions to users. While the marketplace and payment applications 130 and 132 are shown in FIG. 1 to both form part of the network-based system 112, it will be appreciated that, in alternative embodiments, the payment applications 132 may form part of a payment service that is separate and distinct from the network-based system 112.

In the instance where the client system 120 accesses the marketplace applications 130 and payment applications 132 via the MS Interface, the client system 120 may use an “instant messaging” service via an IM Host server 116 for substantially instant messaging. In example embodiments, the IM host server 116 may be selected from a group including Skype®, Yahoo® IM, AIM® of AOL®, MSN® Messenger of Microsoft®, and ICQ® of the ICQ Network. The IM Host server 116 may be included within the network-based system 112 and therefore enable secure transactions with the application server(s) 128, and may specifically be included within the payment application(s) 132.

The client system 120 may access the application servers 128, such as the various marketplace applications 130 and payment applications 132, via a Webbot 118, and via a system interface. The Webbot 118 may be a dynamic Web page object evaluated when the webpage is opened in a Web browser or saved. In example embodiments, the Webbot 118 includes a Jabber® host or server interface. The Webbot 118 may be a streaming XML technology that may be used for instant messaging. The Webbot 118 may be open-source, neutral, and universal to enable communications between the network-based system 112 and any server, such as the IM host server 116. Further, the Webbot 118 may be decentralized (i.e., located within the network-based system 112) and therefore enable secure transactions between the client system 120 and the network-based system 112.

Decentralizing the Webbot may enable secure transactions. In particular, the information may be encrypted because an application may be on the client's machine, where information may be encrypted without network exposure.

The system interface between the client system 120 and the applications 130 and 132 may include a programmatic interface supported by an Application Program Interface (API) server 124, a Messaging Service (MS) Interface supported by an MS Gateway Server 125, and/or a web interface supported by a web server 126. The web interface may include a web browser or any microbrowser, such as xHTML or WAP. Similarly, the programmatic/web client 122 accesses the various services and functions provided by the application server(s) 128, via the programmatic interface provided by the API server 124 and/or the web server 126. The programmatic/web client 122 may, for example, be a seller application (e.g., TurboLister® application) to enable sellers to author and manage listings on the network-based system 112 in an off-line manner, and to perform batch-mode communications between the programmatic/web client 122 and the network-based system 112.

In an additional embodiment, an application supported by one or more applications of the application server(s) may be downloadable to the network-based device. The device(s) may host the interface associated with the one or more applications of the application server(s) 128. The interface on the device may be an API interface, an MS interface, a web interface, and/or another appropriate communication interface. Consumer wireless device platforms, such as Java 2 Platform Micro Edition (J2ME), J2SE and J2EE allow developers to use Java and a wireless toolkit to create applications and programs for the client system 120. The J2ME interface may include an application programming interface (API) for the device. The application of the programmatic client may also access the Internet using, for example, Binary Runtime Environment for Wireless (BREW).

The programmatic/web client 122 executed on the client system 120 may access the application server(s) 128 via the web interface of the web server. The programmatic/web client 122 may be selected on the client system 120 which may cause the Internet to be launched in a background process. The programmatic/web client 122 may additionally or alternatively access the server(s) 128 via the MS interface of the MS Gateway server 125, and/or via the programmatic interface of the API server 124. In an embodiment, the downloaded application described herein may include the programmatic/web client 122.

The client system 120 may host the interface associated with one or more payment application(s) 132 of the server(s) 128. The programmatic/web client 122 may be associated with a financial service provider (FSP) of the payment application(s). In an additional embodiment, the programmatic/web client 122 may be associated with a third party application 138 of a third party server 140. The third party application may, for example, provide one or more promotional, marketplace or payment functions that are supported by the relevant applications of the network-based system 112. For some example embodiments, the third party application may generate an electronic invoice and may transmit the electronic invoice to the payment applications 132 for processing.

The payment application(s) and/or the FSP may operate independent of the third party. The payment application(s) and/or the FSP may be related to the third party, in other embodiments.

The payment applications 132 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 130. The payment applications 132, e.g., a financial service provider, may also extend credit to user, and/or may also have access to other funding sources to complete transactions—e.g. a credit card, a bank account, and/or a credit line. The FSP may operate using the payment application(s) 132.

The WebBot 118 may be part of the payment application(s) 132 in some embodiments. In an example, through the WebBot 118, and in response to a prompt from an application executed on the client system 120, the user may submit a payment transaction request to the payment application(s). A payment transaction from a user to a third party vendor may then be created. The payment application(s) 132 may send a payment confirmation message, e.g., via IM and the IM host server 116, to the user and/or the third party vendor.

The third party or vendor may receive, from the payment application(s) and/or the FSP, information regarding a requested payment transaction for a product, a service, or a donation amount, information regarding the shipment address specified by the client user, and payment confirmation. The payment application(s) and/or the financial service provider may secure financial information of the client user with respect to the third party. The FSP may not be sharing the financial information of the client user with the third party. For example, the payment may be received by the third party exclusive of the payment method and/or financial information of the client user, including credit card information, bank information and/or other client user account information.

The network-based system 112 and the various marketplace and payment applications 130 and 132 may also be implemented as standalone software programs, which do not necessarily have networking capabilities. In this example, the client system 120 may be directly connected to the marketplace application(s) 130 and/or payment application(s) 132, without using the network 114. In other examples, the network-based system 112 may be any online marketplace (e.g., eBay marketplace, etc.)

The application server(s) 128 may be coupled to one or more database servers 134 that facilitate access to one or more databases 136. The application(s) may have access to the database(s) 136 having, for example, personal user account information. The user account information may include payment information associated with the client user and an address destination of the client user, for example.

The programmatic/web client 122 may operate a program supported by the one or more database server(s) 134. The database server(s) 134 may support one or more account information links on a user interface of the network-based device, for example, using the programmatic/web client 122. By accessing the database server(s) 134, the client user may add, amend or delete account information of the client user, among other information. In an embodiment, the client user may select a default shipment address and a default payment method in the payment application(s) discussed herein. Depending on whether goods are purchased, a service is requested, a donation is made, or a promotion is selected, a default shipment address, e.g. electronic mail address or a residential address, a business addresses, or a P.O. Box, may be selected by the client user in the payment application(s). One of the default payment methods may include direct transfers from system account balances, internal credit, a gift certificate, a bank account, a debit card, buyer credit, and/or a credit card.

The payment application(s) 132 may transfer funds (or other value) between users. The payment application 132 may, responsive to the server(s) receiving a payment transaction request from the user, transfer a payment from the user to the third party. The payment may be automatically transferred, as discussed herein.

For some example embodiments, the payment applications 132 may be associated with a payment facilitator (e.g., PayPal®), the third party server 140 may be associated with a merchant (e.g., a restaurant), and the users may be consumers or clients of the merchant. For some example embodiments, the payment transaction request from the user may be associated with a transaction code generated by the payment applications 132 and an electronic invoice generated by the third party server 140.

In an example embodiment of the present invention, a buyer or a consumer may be a client user that submits a purchase request, such as a purchase initiation code associated with a promotion offer, for example, or associated with an offer of an online marketplace or another marketplace medium, to the FSP. The user may submit the purchase initiation code through the network-based device while in an established communication session with the payment application 132. The communication session may include an instant message communication session, or a telephone call, or a website, for instance. The user may be requested to submit verification of identity, such as a password and username, upon making the purchase request, as discussed herein. Payment in connection with the request may be made using the FSP, for example, by debiting a first user account and crediting a second user account (or vendor account), accordingly. A means for transferring the payment is through the payment application 132.

### Application Server(s)

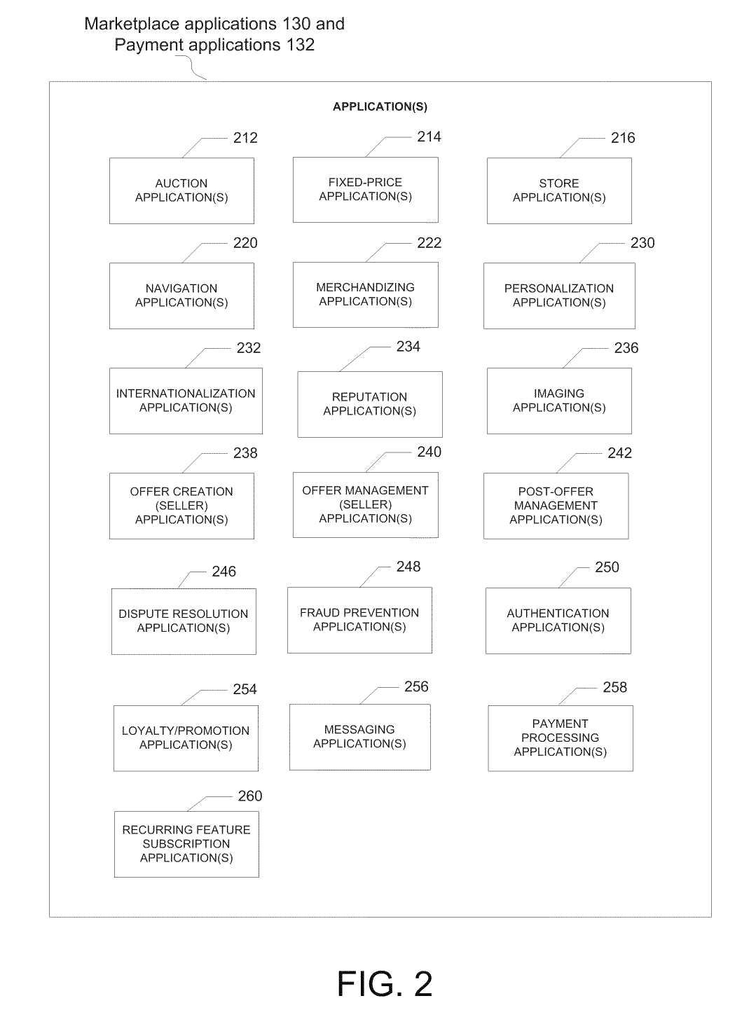

FIG. 2 illustrates a block diagram showing application server(s) that are part of the network-based system 112, in an example embodiment of the present invention. In this embodiment, the marketplace application(s) 130, and the payment application(s) 132 may be hosted by the application server(s) 128 of the network-based system 112. The marketplace application(s) 130 and the payment application(s) 132 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

The marketplace application(s) 130 are shown to include at least one or more auction applications 212 which support auction-format listing and price setting mechanisms (e.g., English, Dutch, Vickrey, Chinese, Double, Reverse auctions etc.). The auction applications 212 may also provide a number of features in support of such auction-format listings, such as a reserve price feature whereby a seller may specify a reserve price in connection with a listing and a proxy-bidding feature whereby a bidder may invoke automated proxy bidding. The auction-format offer in any format may be published in any virtual or physical marketplace medium and may be considered the point of sale for the commerce transaction between a seller and a buyer (or two users).

One or more fixed-price application(s) 214 support fixed-price listing formats (e.g., the traditional classified advertisement-type listing or a catalogue listing) and buyout-type listings. Specifically, buyout-type listings (e.g., including the Buy-It-Now® (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

The application(s) of the application server 128 may include one or more store application(s) 216 that allow a seller to group listings within a “virtual” store. The virtual store may be branded and otherwise personalized by and for the seller. Such a virtual store may also offer promotions, incentives and features that are specific and personalized to a relevant seller.

Navigation of the online marketplace may be facilitated by one or more navigation applications 220. For example, a search application (as an example of a navigation application) may enable key word searches of listings published via the network-based system 112. A browse application may allow users to browse various category, catalogue, or inventory data structures according to which listings may be classified within the network-based system 112. Various other navigation applications may be provided to supplement the search and browsing applications.

Merchandizing applications 222 support various merchandising functions that are made available to sellers to enable sellers to increase sales via the network-based system 112. The merchandizing applications 222 also operate the various merchandising features that may be invoked by sellers, and may monitor and track the success of merchandising strategies employed by sellers.

Personalization applications 230 allow users of the network-based system 112 to personalize various aspects of their interactions with the network-based system 112. For example, a user may, utilizing an appropriate personalization application 230, create a personalized reference page at which information regarding transactions to which the user is (or has been) a party may be viewed. Further, the personalization application(s) 230 may enable a third party to personalize products and other aspects of their interactions with the network-based system 112 and other parties, or to provide other information, such as relevant business information about themselves.

The marketplace application(s) 130 may include one or more internationalization applications 232. In one embodiment, the network-based system 112 may support a number of marketplaces that are customized, for example, for specific geographic regions. A version of the network-based system 112 may be customized for the United Kingdom, whereas another version of the network-based system 112 may be customized for the United States. Each of these versions may operate as an independent marketplace, or may be customized (or internationalized) presentations of a common underlying marketplace. The network-based system 112 may accordingly include a number of internationalization applications 232 that customize information (and/or the presentation of information) by the network-based system 112 according to predetermined criteria (e.g., geographic, demographic or marketplace criteria). For example, the internationalization applications 232 may be used to support the customization of information for a number of regional websites that are operated by the network-based system 112 and that are accessible via respective web servers.

Reputation applications 234 allow users that transact, utilizing the network-based system 112, to establish, build and maintain reputations, which may be made available and published to potential trading partners. Consider that where, for example, the network-based system 112 supports person-to-person trading, users may otherwise have no history or other reference information whereby the trustworthiness and credibility of potential trading partners may be assessed. The reputation applications 234 allow a user, for example through feedback provided by other transaction partners, to establish a reputation within the network-based system 112 over time. Other potential trading partners may then reference such a reputation for the purposes of assessing credibility and trustworthiness.

In order to make listings, available via the network-based system 112, as visually informing and attractive as possible, the marketplace applications 130 may include one or more imaging applications 236 utilizing which users may upload images for inclusion within listings. An imaging application 236 also operates to incorporate images within viewed listings. The imaging applications 236 may also support one or more promotional features, such as image galleries that are presented to potential buyers. For example, sellers may generally pay an additional fee to have an image included within a gallery of images for promoted items.

The marketplace application(s) 130 may include one or more offer creation applications 238. The offer creation applications 238 allow sellers conveniently to author products pertaining to goods or services that they wish to transact via the network-based system 112. Offer management applications 240 allow sellers to manage offers, such as goods, services, or donation opportunities. Specifically, where a particular seller has authored and/or published a large number of products, the management of such products may present a challenge. The offer management applications 240 provide a number of features (e.g., auto-reproduct, inventory level monitors, etc.) to assist the seller in managing such products. One or more post-offer management applications 242 also assist sellers with a number of activities that typically occur post-offer. For example, upon completion of an auction facilitated by one or more auction applications 212, a seller may wish to leave feedback regarding a particular buyer. To this end, a post-offer management application 242 may provide an interface to one or more reputation applications 234, so as to allow the seller conveniently to provide feedback regarding multiple buyers to the reputation applications 234.

The dispute resolution application(s) 246 may provide mechanisms whereby disputes arising between transacting parties may be resolved. For example, the dispute resolution applications 48 may provide guided procedures whereby the parties are guided through a number of steps in an attempt to settle a dispute. In the event that the dispute cannot be settled via the guided procedures, the dispute may be escalated to a mediator or arbitrator.

The fraud prevention application(s) 248 may implement various fraud detection and prevention mechanisms to reduce the occurrence of fraud within the network-based system 112. The fraud prevention application(s) may prevent fraud with respect to the third party and/or the client user in relation to any part of the request, payment, information flows and/or request fulfillment. Fraud may occur with respect to unauthorized use of financial instruments, non-delivery of goods, and abuse of personal information.

Authentication application(s) 250 may verify the identity of a user, and may be used in conjunction with the fraud prevention application(s) 248. The user may be requested to submit verification of identity, an identifier upon making the purchase request, for example. Verification may be made by a code entered by the user, a cookie retrieved from the device, a phone number/identification pair, a username/password pair, handwriting, and/or biometric methods, such as voice data, face data, iris data, finger print data, and hand data. In some embodiments, the user may not be permitted to login without appropriate authentication. The system (e.g., the FSP) may automatically recognize the user, based upon the particular network-based device used and a retrieved cookie, for example.

The network-based system 112 itself, or one or more parties that transact via the network-based system 112, may operate loyalty programs and other types of promotions that are supported by one or more loyalty/promotions applications 254. For example, a buyer/client user may earn loyalty or promotions points for each transaction established and/or concluded with a particular seller/third party, and may be offered a reward for which accumulated loyalty points can be redeemed.

The application server(s) 128 may include messaging applications 256. The messaging applications 256 are responsible for the generation and delivery of messages to client users and third parties of the network-based system 112. Information in these messages may be pertinent to services offered by, and activities performed via, the payment application(s) 132.

Such messages, for example, advise client users regarding the status of products (e.g., providing “out of stock” or “outbid” notices to client users) or payment status (e.g., providing invoice for payment, Notification of a Payment Received, delivery status, invoice notices). Third parties may be notified of a product order, payment confirmation and/or shipment information. Respective messaging applications 256 may utilize any one of a number of message delivery networks and platforms to deliver messages to users. For example, messaging applications 256 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

The payment application(s) 132 may include one or more payment processing applications 258. The payment processing application(s) 258 may receive electronic invoices from the merchants and may receive payments associated with the electronic invoices. The payment application(s) 132 may also make use of functions performed by some applications included in the marketplace application(s) 130.

For some example embodiments, the marketplace application(s) 130 may include one or more recurring-feature subscription service application(s) 260. The recurring-feature subscription service application(s) 260 may detect that a subscription is valid and may automatically renew a service before expiration. Other features of the recurring-feature subscription service application(s) will be described in more detail below.

### Recurring Features

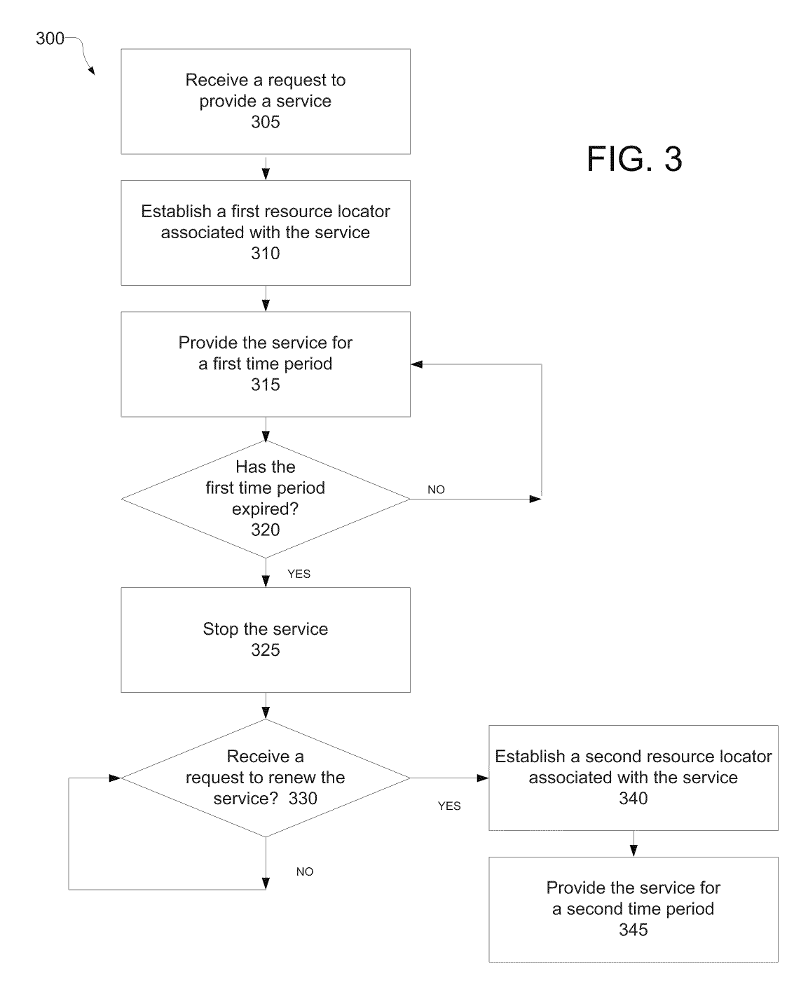

FIG. 3 is a flow diagram illustrating one example of operations that may be performed by the recurring-feature subscription service application(s), in accordance with some example embodiments.

At block 305, a request is received to provide a service. The service may be any type of services that use the Internet to attract attention of users. For example, the service may be an advertising service of a network-based marketplace to advertise or promote an item to the users of the marketplace. In the following examples, references to an online marketplace are used merely for the purpose of discussions and not intended to be restrictive.

At block 310, a resource locator or an identifier is established and associated with the service. A resource locator may be a network link that enables the service to be identified by the marketplace. For some example embodiments, the resource locator (as in uniform resource locator or URL) may also enable the service to be identified by the Internet.

At block 315, the service becomes active and remains active during a first time period (e.g., 30 days). The first time period may be determined by the marketplace. Alternatively, the first time period may be selected by the requester of the service.

At block 320, a test is performed to determine if the first time period has expired. If it has not expired, the service remains active. If it has expired, the process flows to block 325 where the service is stopped (e.g., the advertisement is stopped). For some example embodiments, when the service is stopped, the resource locator for the service becomes invalid.

At block 330, a test is performed to determine if a request to reactivate the service is received. If no request is received, then the process may either stop, or it may wait until a request is received. If a request is received, the process may flow to block 340, where another resource locator is established and associated with the service. At block 345, the service becomes active for a second time period. The second time period may be the same time length as the first time period, or it may be different.

The process of FIG. 3 has some drawbacks in that different resource locators are used to identify the same service. One drawback is the consequence of the invalid link. As an example, when the service is about advertising a classic 1961 Chrysler automobile, the first resource locator that identifies the automobile during the first time period is not valid when the first time period expires. Since the first resource locator may have already been indexed by search engines or referenced by many web sites, selecting the first resource locator after the first time period expires will cause a “Not Found” error message to be displayed. This is commonly referred to as a 404 error. In this situation, the “Not Found” error message incorrectly conveys to the users that the automobile is not available.

Another drawback is the lack of “freshness” as perceived by the search engines or search operations. As an example, search engines may prefer to rank search results based on how current each of the entries in search results is. More current or “fresher” entries are usually listed toward the top, while “older” entries are listed toward the bottom of the search results. In the automobile example, the longer the 1961 Chrysler remains available for potential customers during the first time period, the “older” it is perceived by the search engines. Thus, when using “Classic Chrysler” as the search parameters, the 1961 automobile in this example will be displayed toward the bottom of the search results below other “fresher” classic Chrysler automobiles that are available. In other words, the 1961 classic Chrysler keeps getting bumped down, getting less exposure to potential customers as time progresses until the first period expires.

### Recurring Feature Subscription Service Applications

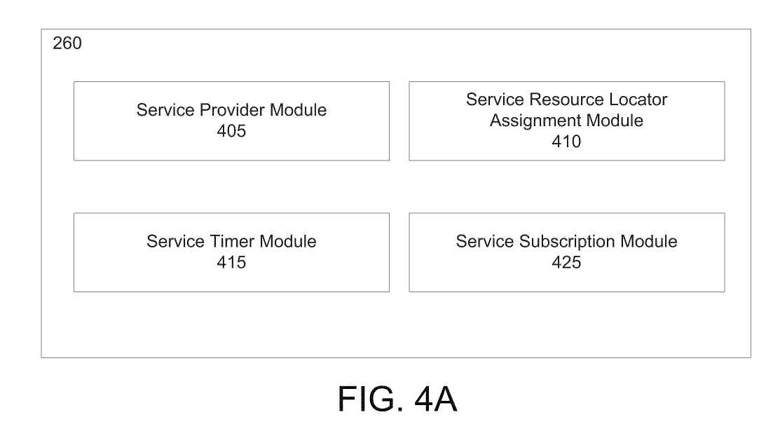

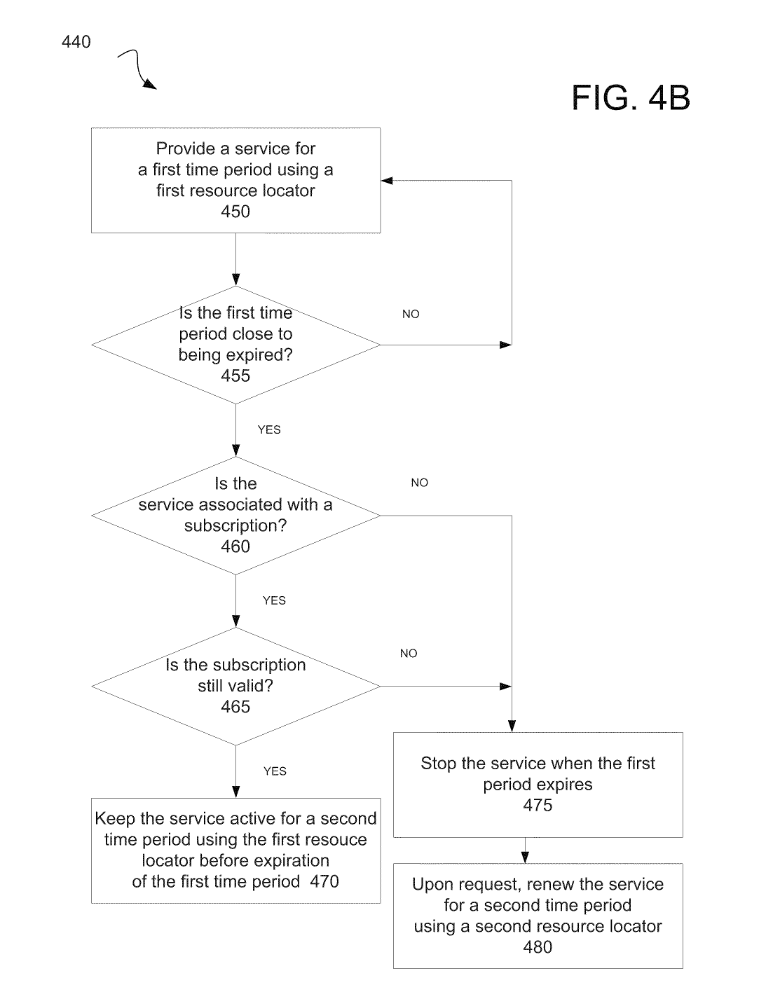

FIG. 4A is a block diagram illustrating one example a recurring service application, in accordance with some example embodiments. The recurring service application 400 may include a service provider module 405, a service resource locator assignment module 410, a service timer module 415 and a service subscription module 425. The service provider module 405 is configured to receive the request for a service (e.g., request to advertise an item) and to provide the service (e.g., advertise the item). The service resource locator assignment module 410 is configured to assign a resource locator and to associate the resource locator with the service. The resource locator may be unique. The service timer module 415 is configured to keep track of when the service becomes inactive. The service becomes inactive when the time period associated with the service expires. The service subscription module 425 is configured to receive subscription requests and to prevent the service from becoming inactive while the subscription is valid.

### Flow Diagram—Recurring Feature Subscription Service

FIG. 4B is a flow diagram illustrating one example of operations that may be performed by the recurring-feature subscription service application(s), in accordance with some example embodiments.

The flow diagram 440 may start at block 450 where a service is provided during a first time period using a first resource locator. At block 455, a test is performed to determine if the first time period close to being expired. For example, a time period has an expiry and the test determines whether the time period is about to reach expiry, the length of time period being at the designer's choice. If it is not close to being expired, the process flows back to block 450 where the service is continued to be provided.

From block 455, if the first time period is close being expired, the process flows to block 460 where a test is performed to determine whether the service is associated with a subscription. If there is no valid subscription, the process flows to block 475 and the service is stopped. At block 480, a request to renew the service may be received and the service is again provided during a second time period. This time with a different resource locator.

From block 460, when there is a subscription, the process flows to block 465 where a test is performed to determine if the subscription is still valid. It may be noted that the subscription may only be valid for as long as it is paid for. For example, a subscription may be purchased for one year to cover a service that would expire every 30 days. This subscription will allow the service to remain active for up to 12 months. At the thirteenth month, the subscription becomes invalid unless renewed.

From block 465, if the subscription is invalid, the process flows to block 475 and 480 as described above. If the subscription is valid at block 465, the process flows from block 465 to block 470 where the service is prevented from being stopped even after the first time period expires while using the same first resource locator. Those of ordinary skill in the art will recognize that the test of block 460 may test for the subscription remaining valid during the next time period. That is, block 460 may test that the subscription is, or will continue to be, valid after expiry of the first time period. Further, after block 470 the process may then begin again at block 455 to test for a subsequent or next time period, and the process may continue until the subscription becomes or is about to become invalid in the next time period, at which point block 475 will be reached.

Examples of Resource Locators Associated with Same Service

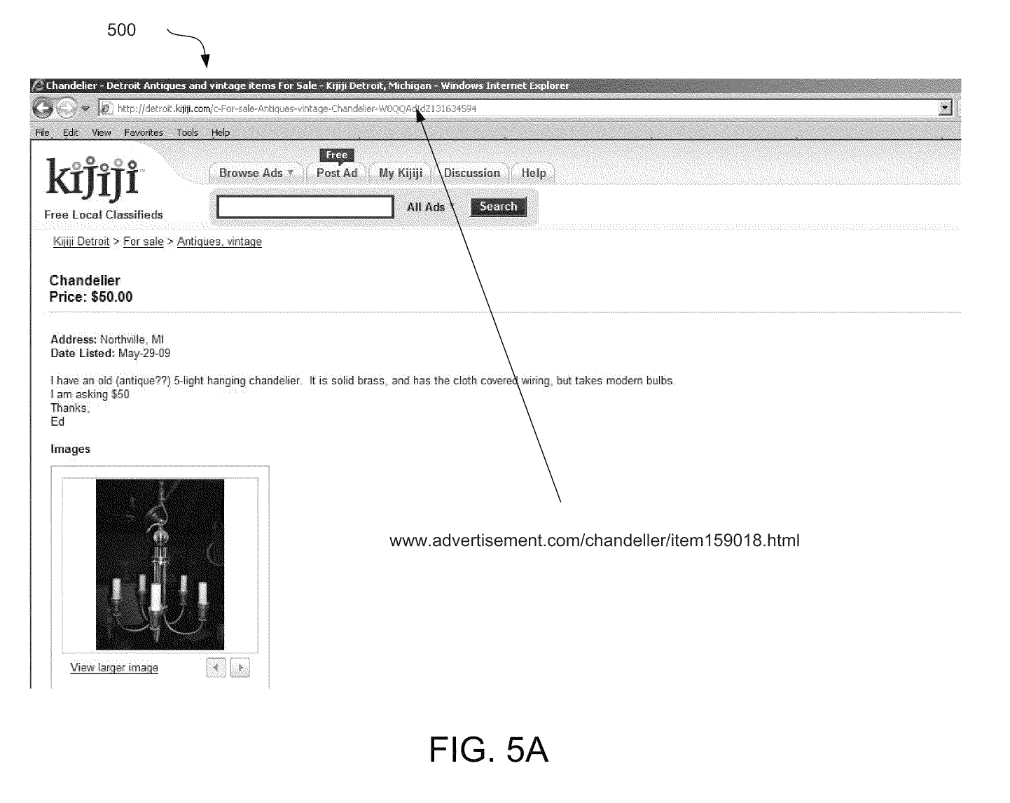

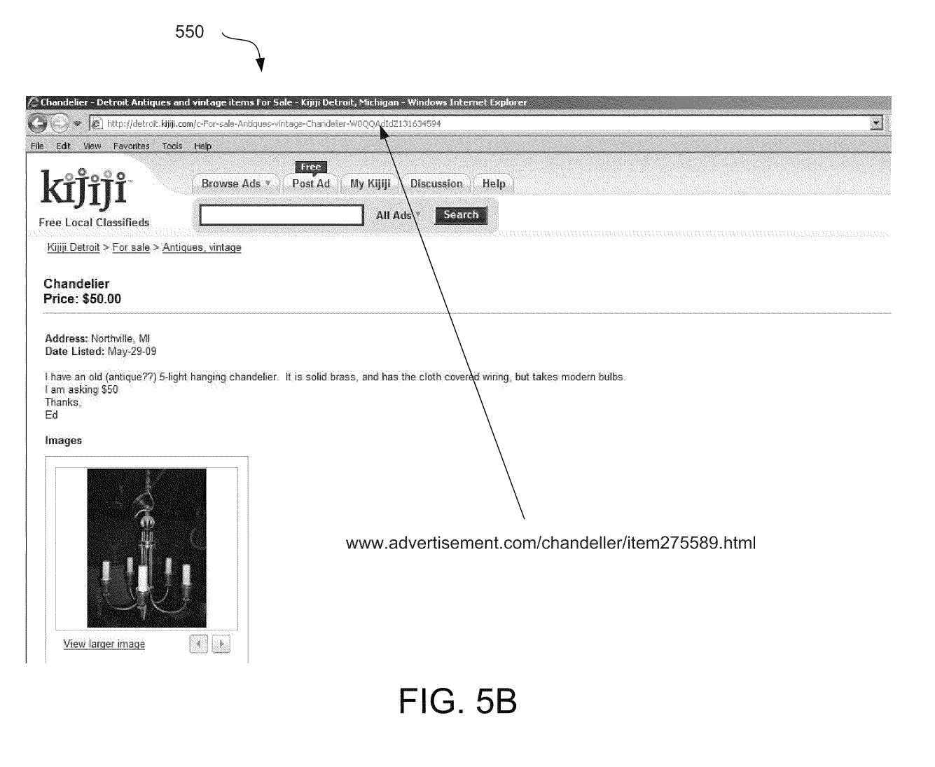

FIGS. 5A and 5B are screen shot examples of an advertisement associated with a first resource locator during a first time period and a second resource locator during a second time period, in accordance with some example embodiments. These examples are used to illustrate a situation when there is no valid recurring feature subscription service. As illustrated by the arrows, the resource locator for the same item being advertised is different in FIG. 5A and in FIG. 5B. In this example, since there is no valid subscription, only the first resource locator is valid during the first time period and only the second resource locator is valid during the second time period. There may be a time gap between the first time period and the second time period.

When there is a valid subscription, the first resource locator is used both during the first time period and the second time period, and there is no time gap between the first time period and the second time period.

### Activating Subscription Service

As discussed above with the search engine examples, as time progresses bumping down may occur causing the search results to show fresher search entries toward the top. For some example embodiments, the recurring feature subscription service application 260 may periodically “freshen” up the service to prevent being bumped down and further to cause a bumping up effect. In other words, the subscription applications may perform operations to make the service behave as if it is a “fresh” service. For example, the subscription may cause the Chrysler automobile be perceived as if it were a new advertisement rather than an advertisement that has been posted for 10 days. This bumping effect enables the service to have more exposure to the users as compared to getting less and less exposures due to the bumping down effect.

### Platform Architecture

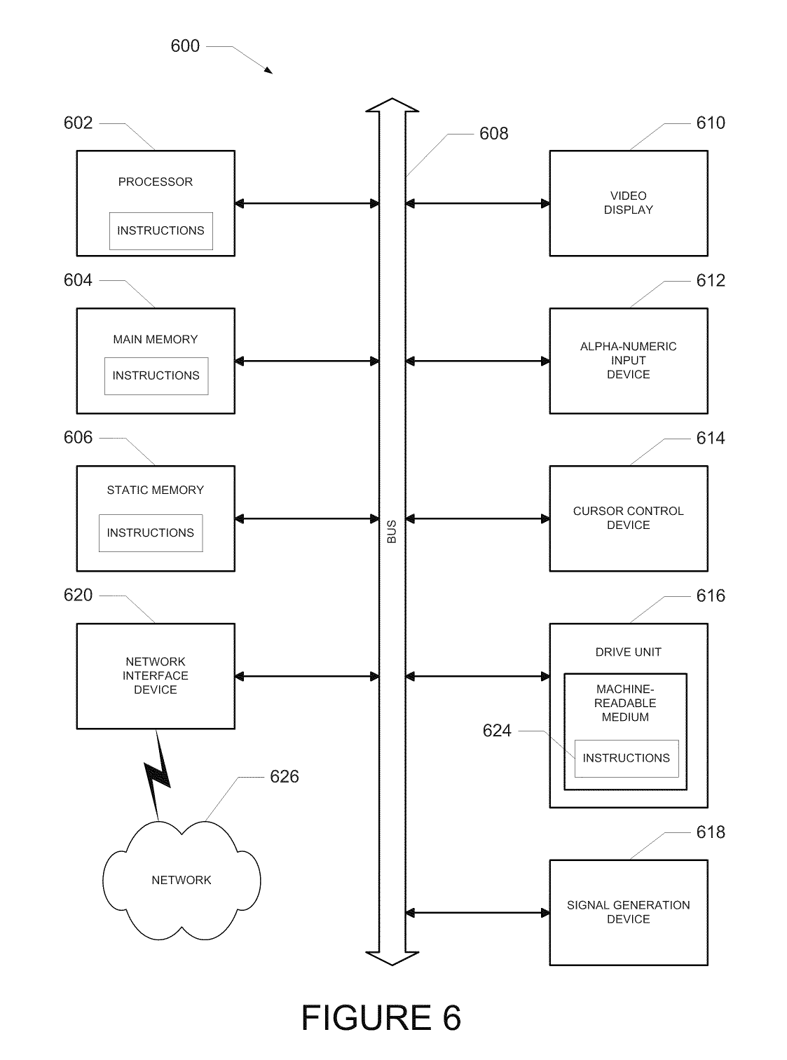

FIG. 6 shows a diagrammatic representation of a machine in the example form of a computer system 600 within which a set of instructions, for causing the machine to automatically perform any one or more of the methodologies discussed herein, may be executed. In alternative embodiments, the machine operates as a standalone device or may be connected (e.g., network) to other machines. In a network deployment, the machine may operate in the capacity of a server or a client user machine in server-client user network environment, or as a peer machine in a peer-to-peer (or distributed) network environment. The machine may be a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a television, television cable a pager, a personal trusted device, a web appliance, a network router, switch or bridge, or any machine capable of executing a set of instructions (sequential or otherwise) that specify actions to be taken by that machine.

Further, while a single machine is illustrated, the term “machine” shall also be taken to include any collection of machines that individually or jointly execute a set (or multiple sets) of electronically-coded instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal displays (LCD) or a cathode ray tube (CRT)). The computer system 600 also includes an input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of electronically-coded instructions (e.g., software 624) embodying any one or more of the methodologies or functions described herein. The instructions 624 may also reside, completely or at least partially, within the main memory 604, the static memory 606, and/or within the processor 602 during execution thereof by the computer system 600. The main memory 604 and the processor 602 also may constitute machine-readable media.

The instructions 624 may further be transmitted or received over a network 626 via the network interface device 620.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. FIGS. 1 to 6 are merely representational and may not be drawn to scale. Certain proportions thereof may be exaggerated, while others may be minimized.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The description includes terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the examples of dimensions and ranges are considered typical, the various embodiments are not limited to such dimensions or ranges.

What is claimed is:

1. A computer-implemented method comprising:
providing, by a computer processor coupled to storage and operating at least one recurring feature subscription application, a valid subscription to be used with a service;
using a resource locator for the service;
preventing the service from becoming inactive at or after the expiry of a time period after which the subscription will remain valid; and
using the resource locator for the service after the expiry.

2. The method of claim 1, the method responding to the subscription becoming, or being about to become, invalid at or after the expiry by (a) causing the service to become inactive after the expiry, and (b) associating a second resource locator with the service.

3. The method of claim 2, wherein the second resource locator is assigned to the service after the service is caused to become inactive.

4. The method of claim 1, further comprising causing the service to receive exposure to prospective customers as if the service were newer than it is.

5. The method of claim 4 wherein the exposure is provided by one or more search engines.

6. The method of claim 4, wherein causing the service to receive exposure comprises displaying the service in a visible section of a web page.

7. The method of claim 1, the recurring feature subscription application comprising a service provider module in the storage, the service provider module having software to process a request for service and to provide the service.

8. The method of claim 1, the recurring feature subscription application comprising a service resource locator assignment module in storage, the assignment module having software to assign a resource locator and to associate the resource locator with the service.

9. The method of claim 8 wherein the resource locator is unique.

10. The method of claim 1, the recurring subscription application comprising a service timer module in storage, the service timer module having software to keep track of when the service becomes, or is about to become, inactive.

11. The method of claim 1, the recurring feature subscription application comprising a service subscription module in storage, the service subscription module having software to process one or more subscription requests and to prevent the service from becoming inactive while the subscription is valid.

12. A computer-implemented method comprising using at least one computer processor for:
providing a service over the Internet using a resource locator during a time period having a predetermined expiry,
determining whether the time period is close to the expiry and whether the service is associated with a valid subscription that is, or will continue to be, valid after the expiry; and
responsive to determining that the time period is close to the expiry and that the service is associated with a subscription that is, or will continue to be, valid after the expiry, continuing the service after the expiry the resource locator.

13. The method of claim 12, the method determining that the subscription is, or will continue to be, valid for at least one additional time period after the expiry and repeating the method for the at least one additional time period.

14. The method of claim 13, the method further comprising freshening up the subscription service in order to prevent the service from being bumped down on a search engine's search results page.

15. A non-transitory computer-readable storage device having embedded therein a set of instructions which, when executed by one or more processors of the computer causes the computer to execute the following operations:
providing a service over the Internet using a resource locator during a time period having a predetermined expiry,
determining whether the time period is close to the expiry and whether the service is associated with a valid subscription that is, or will continue to be, valid after the expiry; and
responsive to determining that the time period is close to the expiry and that the service is associated with a subscription that is, or will continue to be, valid after the expiry, continuing the service for a second time period after the expiry, and continuing to use the resource locator for the service.

16. The computer-readable storage device of claim 15, the one or more operations further comprising determining that the subscription is, or will continue to be, valid for at least one additional time period after the expiry and repeating the method for the at least one additional time period.

17. The computer-readable storage device of claim 16, the one or more operations further comprising freshening up the subscription service in order to prevent the service from being bumped down on a search engine's search results pages.

18. A non-transitory computer-readable storage device having embedded therein a set of instructions which, when executed by one or more processors of the computer causes the computer to execute the following operations:
providing a valid subscription to be used for a service, the service capable of recurring after a time period having a predetermined expiry;
using a resource locator for the service;
preventing the service from becoming inactive at or after the expiry after which expiry the subscription will remain valid; and
using the resource locator for the service after the expiry.

19. A computer system comprising:
At least one computer processor coupled to storage, the storage including software for least one recurring feature subscription application for providing a subscription to be used with a service, the recurring feature subscription application comprising:
a service provider module in storage, the service provider module having software to process a request for service and to provide the service;
a service resource locator assignment module in storage, the assignment module having software to assign a unique resource locator and to associate the resource locator with the service;
a service timer module in storage, the service timer module having storage to keep track of when the service becomes, or is about to become, inactive; and
a service subscription module in storage, the service subscription module having software to process one or more subscription requests and to prevent the service from becoming inactive while the subscription is valid.
